(19) United States
(12) Patent Application Publication
(10) Pub. No.: US 2005/0055595 A1
(43) Pub. Date: Mar. 10, 2005

(54) Software update method, apparatus and system

(76) Inventors: Mark Frazer, Toronto Ontario (CA); Philippe A. Rivard, Toronto Ontario (CA)

Correspondence Address: KATTEN MUCHIN ZAVIS ROSENMAN, 525 WEST MONROE STREET, CHICAGO, IL, 60661-3693, US

(21) Appl. No.: 10/489,777

(22) PCT Filed: Sep. 17, 2002
(86) PCT No.: PCT/CA02/01414

(30) Foreign Application Priority Data
Sep. 17, 2001 (CA) 2,357,382

(51) Int. Cl. H04L 5/00

(52) U.S. Cl. 713/400

(57) ABSTRACT

A system for remotely updating software on at least one electronic device connected to a network. The electronic devices have a non-volatile rewritable storage unit divided into at least two partitions, one of which will contain core firmware and the other of which will contain auxiliary software. When an update is received at the device, the updated core firmware is written to overwrite the partition in the rewritable storage unit that contained the auxiliary software. When this is completed and verified, the previous version of the core firmware stored in the storage unit is disabled from execution by the device. Next, the updated auxiliary software is written to overwrite the old version of the core firmware. When this write is complete, the device determines a suitable time for it to be rebooted to execute the updated software. In another embodiment, the present core firmware in the device is copied from the partition it is in to the other partition, overwriting the auxiliary software stored there. The new core firmware received to update the device is overwritten into the first partition, the old copied core firmware being present in case of an upgrade failure, and upon a successful update of the first partition, the auxiliary software is written to the second partition, overwriting the copied old core firmware. In this manner, the position of the core firmware and auxiliary software within the partitions is preserved during normal operation of the device.

### FIELD OF THE INVENTION

The present invention relates generally to a method, apparatus and system for updating software in a remotely located electronic device. More specifically, the present invention relates to a method, system and apparatus for updating software in remotely located electronic devices connected to a network in which the devices can recover from an update failure and complete the update through the network.

### BACKGROUND OF THE INVENTION

Many common electronic devices include rewritable memory that allows software or data that persists in the device, when the device is powered-down, to be changed or replaced. Presently, such rewritable memory is typically flash memory, or equivalents, although other types of memory or storage can be employed. Flash memory is a type of solid-state memory that is nonvolatile, in that it does not lose its data when the power is turned off, and yet is rewritable to contain different data. Flash memory is popular because it is compact, reasonably durable, fast and re-writable. For example, cellular phones use flash memory to hold software implementing telephone features, speed dial numbers, ringing tones, firmware updates, etc. So, as new features or bug fixes are implemented, the firmware in the electronic device can be updated.

However, flash memory or its equivalents are not without disadvantages. One disadvantage is that flash memory is relatively expensive. In devices for which the manufacturer needs to keep the consumer costs low, the devices must be engineered to minimize the amount of flash memory required.

While the ability to update firmware or other software or data in a deployed device is clearly desirable, updating flash memory in an electronic device is not always simple. For example, when most cellular phones require a firmware or other software update, the cell phone must be taken into a local service center where the software can be updated by attaching the cell phone through a wired data link to an update station holding the updated software. If there is a problem in transferring the new software during the update session, resulting in the device being placed into an unknown or inoperable state, the device can be reset and the new software can simply be transferred again until the transfer completes and the device functions properly.

However, this is seldom an attractive option as it requires the active participation or cooperation of the user who must visit the service center. With some devices, such as a wireless local loop subscriber station, taking the subscriber station into a service center means that, in addition to the inconvenience of the trip to the service center, the residence at which the subscriber station is normally located is temporarily without telephone or data services.

Prior attempts have been made to provide updates to non-volatile rewritable memory in devices through the network to which they are attached. For example, a cell phone can receive software updates for its flash memory through the wireless network that services it. However, problems exist with such techniques in that, should the transmission fail or be corrupted for any reason, the device may be left in an unknown or inoperative state. In such a case, unlike the example above at which an update is done at a service center, attempts to resend the update software could be impossible and the user would be left with an inoperable device until it was returned to a service center.

One prior solution to this problem has been to provide separate banks of rewritable memory. U.S. Pat. No. 6,023,620 to Hansson teaches a cell phone system wherein half of a rewritable memory is a bank used to maintain the current version of the software while the updated software is downloaded into a bank that is the other half of the rewritable memory. Once the cell phone determines that the transfer has been successful, e.g., by verifying a CRC, the cell phone switches to using the updated bank of memory and the bank containing the old software is available to receive the next update. A similar prior art solution is taught in U.S. Pat. No. 6,275,931 to Narayanaswamy et al. These arrangements prevent a non-recoverable error from occurring during an update, but require twice as much expensive rewritable memory.

Also, the prior art update methods discussed above typically require the cooperation or participation of the user of the device, either requiring them to visit the service center or requiring them to accept or initiate the transfer of update data through the network. A crucial update, such as one that will improve stability or capacity in the network for the network operator, may be refused or otherwise delayed by some users due to the inconvenience to them. Additionally, with the prior art methods known to the inventors, the updating of each device in the network must be performed separately.

It is desired to have a method and system of reliably updating software or data in non-volatile rewritable memory of devices connected to a network which does not require double the amount of non-volatile rewritable memory in the devices and which can be achieved automatically and in parallel on multiple devices.

### SUMMARY OF THE INVENTION

It is an object of the present invention to provide a novel method, system and apparatus for updating, through a network, software in electronic devices that obviates or mitigates at least one of the above-identified disadvantages of the prior art.

According to a first aspect of the present invention, there is provided a system for remotely updating at least one electronic device across a communications link. The system includes an update server, a volatile memory, a non-volatile rewritable storage unit within said at least one electronic device, and an update client executing on the device. The update server is operable to transfer an update, comprising core firmware and auxiliary software, to the at least one electronic device across the communications link. The volatile memory is used to temporarily store the transfer received from the update server. The non-volatile rewritable storage unit is divided into at least first and second partitions, the first partition storing one of a version of the core firmware and auxiliary software and the second of the partitions storing the other of a version of core firmware and auxiliary software. The update client executes on the device and is operable: (i) to overwrite the version of the auxiliary software stored in one of the first and second partitions with the received updated core firmware stored in the volatile memory and to verify the success of this write; (ii) to configure the device to execute the core firmware stored in (i) upon the next reboot of the device; (iii) to overwrite the version of the core firmware stored in the other of the first and second partition with the received updated auxiliary software store in the volatile memory and to verify the success of this write; and (iv) to reboot the device to execute the updated core firmware and updated auxiliary software.

According to another aspect of the present invention, there is provided a method of updating software in a plurality of remote devices connected to a network. The method includes the steps of: (i) placing an update onto an update server, the update comprising at least a core firmware update; (ii) identifying the devices connected to the network to be updated; (iii) transferring the update from the update server to the identified devices through the network, each identified device verifying the reception of the update, requesting retransmission of and receiving any previously incorrectly received portion of the update; (iv) writing and verifying the core firmware portion of the received update into a partitioned non-volatile rewritable storage unit, the core firmware portion overwriting a partition containing a previously stored version of software while ensuring that a valid copy of the previous version of the core firmware is always present in the storage unit; (v) identifying the verified updated core firmware partition as being the valid core firmware to be used by the device and identifying the previous version of the core firmware as being unusable; and (vi) rebooting the device to load and execute the updated software.

Optionally, before the core firmware portion of the received update is written into the partitioned non-volatile rewritable storage unit, the previous version of the core firmware may be copied over auxiliary software stored in the storage unit and verified, the copy identified as the valid core firmware to be used by the device, and then the original identified as being unusable.

Also, the update may include updated auxiliary software. The auxiliary software is received and verified by the device and then, before the device is rebooted, the unusable previous version of the core firmware is overwritten with the auxiliary software update.

According to another aspect of the present invention, there is provided a system for remotely updating core firmware in at least one electronic device across a communications link. The system includes a memory sub-system within the electronic device and an update server that is operable to transfer an update, including at least the updated version of the core firmware, to the electronic device across the communications link. The memory sub-system includes non-volatile rewritable memory in which the core firmware is stored and which is sufficiently large to store auxiliary software but not large enough to simultaneously store the core firmware, an updated version of the core firmware, and the auxiliary software. The core firmware includes instructions for (i) writing an updated version of the core firmware into the non-volatile rewritable memory so as not to overwrite the previous version of the core firmware and optionally verifying the write, and then (ii) disabling the previous version of the core firmware such that on rebooting of the at least one electronic device the updated version of the core firmware will be loaded and executed.

The core firmware may also include instructions for writing an updated version of the auxiliary software into the non-volatile rewritable memory so as to overwrite at least a portion of the disabled previous version of the core firmware, but not to overwrite the updated version of the core firmware. Optionally the write may be verified.

The memory sub-system may additionally include non-volatile memory in which are stored instructions that are executed when the electronic device reboots and cause the non-volatile rewritable memory to be scanned for a version of the core firmware that is not disabled. When a non-disabled version of the core firmware is found then that version is loaded and executed.

According to yet another aspect of the present invention, there is provided a system for remotely updating core firmware and auxiliary software in at least one electronic device across a communications link. The system includes a memory unit within the at least one electronic device for storing the core firmware and the auxiliary software and an update server that is operable to transfer an update to the at least one electronic device across the communications link. The memory unit includes a non-volatile rewritable memory in which is stored in a first partition, a first memory content that includes the core firmware, and in a second partition large enough to store the first memory content, a second memory content that is small enough to be stored in the first partition and that includes the auxiliary software. The core firmware includes an update client which, after an updated version of the first memory content is received, writes the updated version of the first memory content into the second partition overwriting the second memory content, optionally verifies the write, and disables the first memory content that is contained in first partition, and then after an updated version of the second memory content is received, writes the updated version of the second memory content into the first partition overwriting the disabled first memory content and reboots the electronic device. The memory unit also includes non-volatile memory in which boot-loading instructions are stored that are executed when the electronic device is rebooted. The boot-loading instructions include instructions that when executed search the non-volatile rewritable memory for a version of the first memory content that is not disabled and, when one is found, turn over control of the electronic device to the core firmware stored in that memory content.

Alternatively, the update client may, after an updated version of the first memory content is received, copy the first memory content into the second partition overwriting the second memory content, write the updated version of the first memory content into the first partition overwriting the first memory content, optionally verify the write, and then after an updated version of the second memory content is received, write the updated version of the second memory content into the second partition, optionally verify the write, and reboot the electronic device.

Also alternatively, the update client may, after an updated version of the first memory content is received, reduce the size of the second partition so that it is just large enough to store the updated version of the first memory content, write the updated version of the first memory content into the second partition overwriting the previous contents of the second partition, optionally verify the write, and disable the version of the first memory content that is stored in first partition, and then, after an updated version of the second memory content is received, increase the size of the first partition to include any portion of the non-volatile rewritable memory not in the second partition, write the updated version of the second memory content into the first partition overwriting the previous contents of the first partition, optionally verify the write, and reboot the electronic device.

Optionally, the update client may be further operable to inform the update server as to whether the at least one electronic device is available for updating at a given time, the update server being responsive to the information received from the update client to delay updates to the electronic device when the electronic device is not available for updating. The update server may also prioritize an update such that the update client will make the electronic device available for the update that would otherwise be unavailable.

According to yet another aspect of the present invention, there is provided a memory sub-system for use in an electronic device that includes a non-volatile rewritable memory in which core firmware and auxiliary software are stored. The core firmware includes instructions for writing an updated version of the core firmware into the non-volatile rewritable memory so as to overwrite at least a portion of the auxiliary software, but not to overwrite the previous version of the core firmware, verifying the updated version of the core firmware, and disabling the previous version of the core firmware such that on rebooting of the electronic device the updated version of the core firmware will be loaded and executed. The core firmware may include instructions for writing an updated version of the auxiliary software into the non-volatile rewritable memory so as to overwrite at least a portion of the disabled previous version of the core firmware, but not to overwrite the updated version of the core firmware. The memory sub-system may also include non-volatile memory storing instructions that are executed when the electronic device reboots and cause the non-volatile rewritable memory to be scanned for a version of the core firmware that is not disabled and the version of the core firmware that is not disabled to be loaded and executed.

According to yet another aspect of the present invention, there is provided a memory sub-system for use in an electronic device that includes a non-volatile rewritable memory in which core firmware is stored and which is sufficiently large to store the core firmware and auxiliary software but not large enough to simultaneously store the core firmware. The core firmware includes instructions for writing an updated version of the core firmware into the non-volatile rewritable memory so as not to overwrite the previous version of the core firmware, verifying the updated version of the core firmware, and disabling the previous version of the core firmware such that on rebooting of the electronic device the updated version of the core firmware will be loaded and executed. The core firmware may include instructions for writing an updated version of the auxiliary software into the non-volatile rewritable memory so as to overwrite at least a portion of the disabled previous version of the core firmware, but not to overwrite the updated version of the core firmware. The memory sub-system may also include non-volatile memory storing instructions that are executed when the electronic device reboots and cause the non-volatile rewritable memory to be scanned for a version of the core firmware that is not disabled and the version of the core firmware that is not disabled to be loaded and executed.

According to yet another aspect of the present invention, there is provided for use in an electronic device capable of executing stored instructions and receiving updated versions of such instructions, a memory sub-system for storing such instructions that includes non-volatile rewritable memory and non-volatile memory. In the non-volatile memory boot-loading instructions that are executed when the electronic device is rebooted are stored. In the non-volatile rewritable memory there is stored in a first partition, a first memory content that includes at least instructions necessary to allow the electronic device to restart or continue updating the non-volatile rewritable memory if the electronic device reboots while an update is in progress and in a second partition large enough to store the first memory content, a second memory content that is small enough to be stored in the first partition and that includes all instructions not included in the first memory content that are needed for the normal operation of the electronic device after a reboot. The instructions stored in the first memory content include instructions which, when executed after an updated version of the first memory content is received, write the updated version of the first memory content into the second partition overwriting the second memory content, and disable the first memory content that is contained in first partition, and instructions which, when executed after an updated version of the second memory content is received, write the updated version of the second memory content into the first partition overwriting the disabled first memory content, and reboot the electronic device.

Alternatively, the instructions stored in the first memory content may include instructions which, when executed after an updated version of the first memory content is received, copy the first memory content into the second partition overwriting the second memory content, write the updated version of the first memory content into the first partition overwriting the first memory content, and instructions which, when executed after an updated version of the second memory content is received, write the updated version of the second memory content into the second partition overwriting the disabled first memory content and reboot the electronic device.

Alternatively, the instructions stored in the first memory content may include instructions which, when executed after an updated version of the first memory content is received, reduce if possible the size of the second partition so that it is just large enough to store the updated version of the first memory content, write the updated version of the first memory content into the second partition overwriting the previous contents of the second partition, and disable the version of the first memory content that is stored in first partition, and instructions which, when executed after an updated version of the second memory content is received, increase if possible the size of the first partition to include any portion of the non-volatile rewritable memory not in the second partition, write the updated version of the second memory content into the first partition overwriting the previous contents of the first partition, and reboot the electronic device.

According to yet another aspect of the present invention, there is provided a method of installing an update to software stored in a non-volatile rewritable memory that is not large enough to hold both the update and the software. The method includes the steps of: dividing the update into separately writable portions including a core portion that can be stored in not more than half of the non-volatile rewritable memory; dividing the non-volatile rewritable memory into separately rewritable portions including a core portion including not more than half of the non-volatile rewritable memory and containing the portion of the software corresponding to the core portion of the update and an auxiliary portion just large enough to hold the core portion of the update; writing the core portion of the update into the auxiliary portion of the non-volatile rewritable memory and verifying it; disabling the previous version of the software contained in the core portion of the non-volatile rewritable memory; and writing the portion of the update not included in the core portion of the update into the portion of the non-volatile rewritable memory not included in the core portion of the non-volatile rewritable memory and verifying it.

### BRIEF DESCRIPTION OF THE DRAWINGS

Embodiments of the present invention will now be described, by way of example only, with reference to the attached Figures, in which:

FIG. 1 is a block diagram of a network permitting upgrading of electronic devices in accordance with an embodiment of the invention;

FIG. 2 is a block diagram of an update station, in accordance with an embodiment of the invention;

FIG. 3 is a block diagram of an updateable electronic device, in accordance with an embodiment of the invention, including a memory unit;

FIGS. 4a, 4b and 4c are block diagrams of the memory unit in the electronic device of FIG. 3, in accordance with an embodiment of the invention;

FIGS. 5a, 5b and 5c are block diagrams of memory unit in the electronic device of FIG. 3, in accordance with another embodiment of the present invention;

FIG. 6 is a block diagram of the hierarchy of an update system in accordance with an embodiment of the invention; and

FIG. 7 is a flowchart of an embodiment of the update process of the present invention.

### DETAILED DESCRIPTION OF THE INVENTION

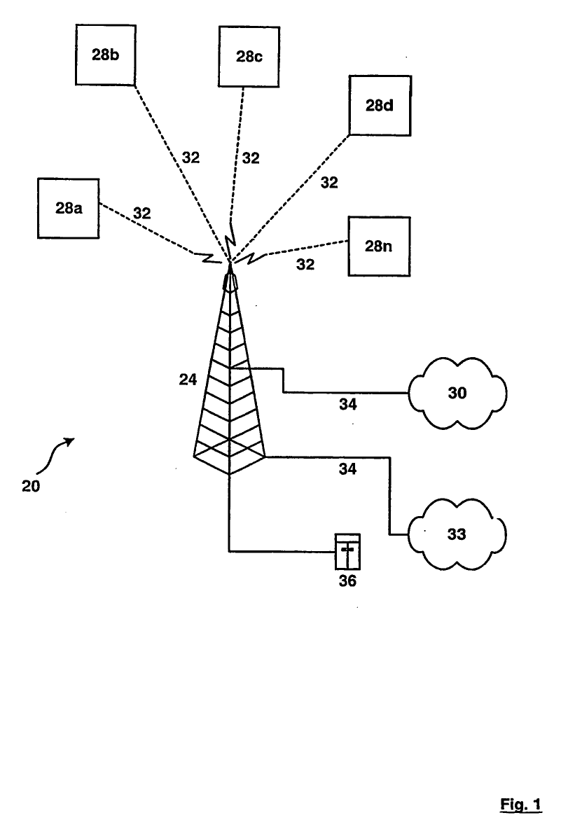

Referring now to FIG. 1, a wireless network that enables the upgrading of software or data in at least one electronics device is indicated generally by reference numeral 20. Network 20 includes at least one update station, which in this example is a radio base station 24, operable to transmit software updates across a bi-directional communication link 32. Network 20 also includes at least one electronic device, such as subscriber stations 28a, 28b, . . . , 28n for a voice and data capable wireless local loop. Subscriber stations 28 can be the customer premises equipment in a wireless local loop for voice and data, wireless point of sale terminals, or any other electronic devices such as personal digital assistants (“PDAs”) that have modems, cellular phones, cable modems, laptop computers, and other suitable electronic devices that will occur to those of skill in the art and that are capable of communicating through communication link 32.

The number ‘n’ of subscriber stations serviced by a base station 24 can vary depending upon the amount of radio bandwidth available or the configuration and requirements of the subscriber stations 28. For the purposes of clarity, references herein to the electronic device being updated will be made only to subscriber stations 28. However, other electronic devices such as those that are mentioned above and that are able to receive software updates across a communication link 32 are within the scope of the invention.

In network 20, base station 24 can be connected to at least one telecommunications network, such as a landline-based switched-data network 30, a public-switched telephone network 33 by an appropriate gateway and backhauls 34. Backhauls 34 can be links such as T1, T3, E1, E3, OC3 or other suitable landline link, or can be a satellite or other radio or microwave channel link or any other link suitable for operation as a backhaul as will occur to those of skill in the art. Base station 24 can also include, or be connected to by a backhaul 34 or other means, a software update server 36 that contains software loads for subscriber stations 28. Base station 24 is also connected to a subscriber database, located in update server 36 or in a separate database server (not shown) provided for this purpose elsewhere, such as in a centralized networks operation center (discussed below), which holds records of the current software loads of subscriber stations 28.

In the wireless network 20, communications link 32 is established between base station 24 and each subscriber station 28 via radio, although other physical means of connection, including wireline, infrared and ultrasonic means can be employed. Communications link 32 can carry voice and data information between base station 24 and respective subscriber stations 28a, 28b . . . 28n as needed. Communications link 32 can be implemented with a variety of multiplexing techniques, including TDMA, FDMA, CDMA, OFDM or hybrid systems such as GSM, etc. Furthermore, communications link 32 can be arranged into different channels carrying different data types such as voice communications or data transmissions or employed for various purposes such as end user communications or control of network 20. In the embodiment of FIG. 1, data transmitted over communications link 32 is transmitted as IP (Internet Protocol) packets, but packets of any suitable type can be employed.

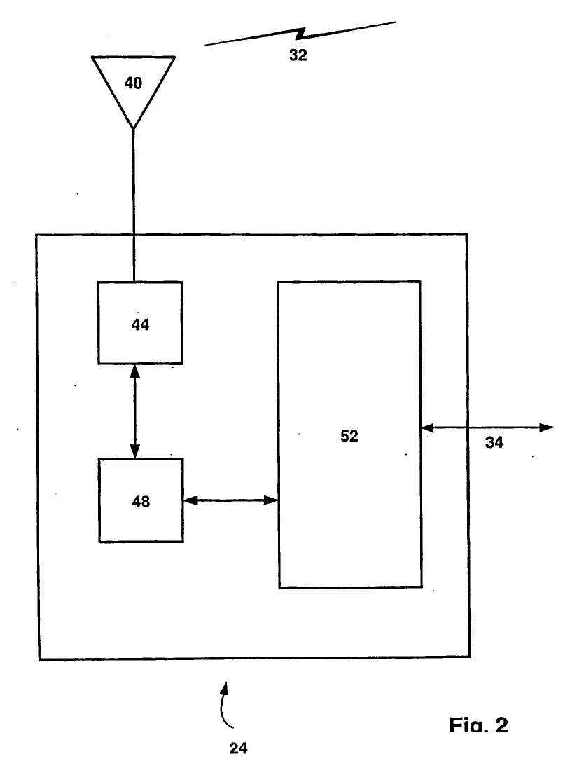

FIG. 2 shows an example of base station 24 in greater detail. Base station 24 comprises an antenna or antennas 40 for receiving and transmitting radio-communications over communications link 32. Antenna 40 is connected to a radio 44, which in turn is connected to a modem 48. Modem 48 is connected to a microprocessor-router assembly 52 such as a Pentium III™ processor system manufactured by Intel and associated devices. It will be understood that microprocessor-router assembly 52 can include multiple microprocessors, as desired. Further, the router functionality of microprocessor-router assembly 52 can be provided in a separate unit, if desired. The router functionality implemented within microprocessor-router assembly 52 is connected to a backhaul 34 in any suitable manner to connect base station 24 to at least one telecommunications network 30, 33. Base station 24 can also be connected directly, or through a backhaul 34, to an update server 36, as mentioned above.

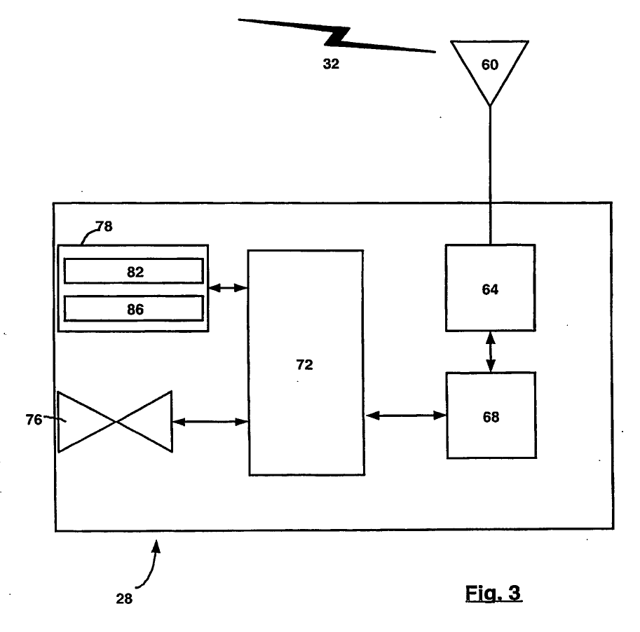

Referring now to FIG. 3, an example of a subscriber station 28 is shown in greater detail. Subscriber station 28 comprises an antenna or antennas 60, for receiving and transmitting radio-communications over communications link 32. Antenna 60 is connected to a radio 64, which in turn is connected to a modem 68. Modem 68 is connected to a microprocessor-assembly 72, which is connected to a memory unit 78.

Microprocessor-assembly 72 can include, for example, a StrongARM processor manufactured by Intel, and performs a variety of functions, including implementing A/D-D/A conversion, filters, encoders, decoders, data compressors, de-compressors and/or packet disassembly. As seen in FIG. 3, microprocessor-assembly 72 also interconnects modem 68 and one or more ports 76, which may be used to connect subscriber station 28 to data devices and telephony devices. An example of a telephony device is a telephone. Examples of data devices include personal computers, PDAs or the like. Accordingly, microprocessor-assembly 72 is operable to process data between ports 76 and modem 68.

In subscriber station 28, memory unit 78 comprises of two principal components: (1) a volatile random access memory (“RAM”) 82, which may be dynamic RAM (DRAM) or synchronous DRAM (SDRAM), used by microprocessor-assembly 72 for storing instructions and data required for operating subscriber station 28; and (2) a non-volatile rewritable storage unit, RSU 86, which in subscriber station 28 is flash memory, used to store data, including instructions, that is not lost when subscriber station 28 is without power. The memory unit 78 is operable to contain all the necessary instructions and data for the proper and desired functioning of subscriber station 28, including boot software, operating systems, software applications, radio resource management software, device drivers, and data files.

As known to those of skill in the art, RAM 82 is typically faster than the flash memory used in the RSU 86 and thus, in a presently preferred embodiment of subscriber station 28, instructions and data are in most cases copied by microprocessor-assembly 72 from the RSU 86 to the RAM 82 before execution. In some circumstances, which will be apparent to those of skill in the art, instructions or data are read into the microprocessor-assembly 72 directly from RSU 86 and executed or operated upon.

Microprocessor-assembly 72 is also operable to write instructions and data from RAM 82 to RSU 86 as described below.

In subscriber station 28, RAM 82 consists of 32 Mbytes of SDRAM and RSU 86 consists of 8 Mbytes of flash memory. However, the quantity and type of RAM memory is not particularly limited and other types of non-volatile rewritable memory, e.g., conventional IDE and SCSI hard drives, optical memory storage devices, and EPROMS may be used instead of flash memory. Other types of non-volatile rewritable memory will occur to those of skill in the art, who will also understand the modifications to the following description that may be needed to use such alternative non-volatile rewritable memory in RSU 86 in an embodiment of the invention.

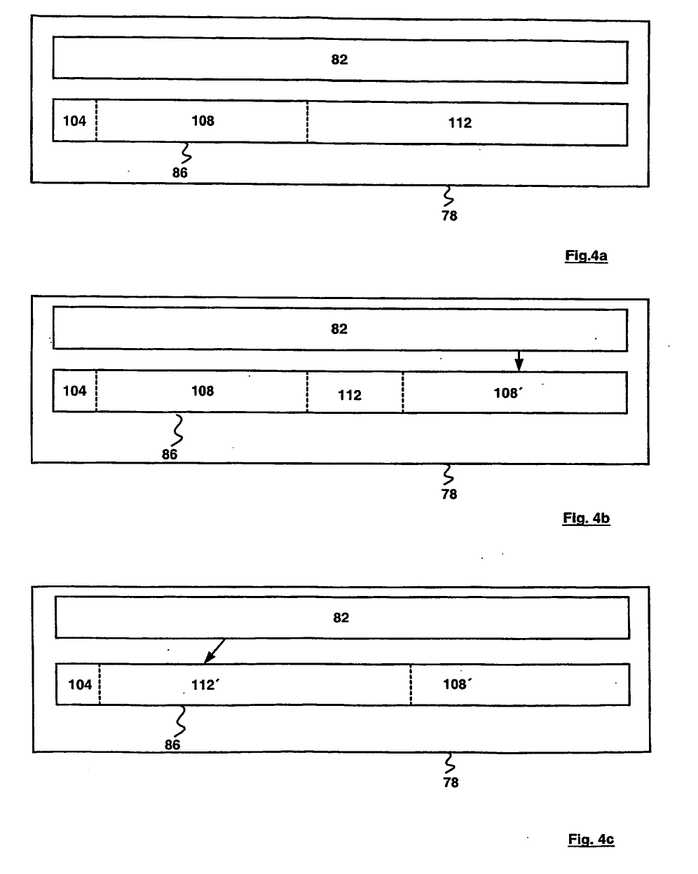

Flash memory, such as that used in RSU 86, must typically be read from and written to in blocks. A block is the smallest unit that can be written to and must be erased before it can be written to. (In other words, flash memory is “granular” which, as will be discussed below, has an impact on the way it is used.) Those skilled in the art will understand that this constraint does not apply to some other forms of non-volatile rewritable memory that could be substituted for flash memory in subscriber station 28. The particular flash memory presently used in subscriber station 28 has a block size of 256 Kbytes. Referring now to FIG. 4a, the initial partitioning of the RSU 86 is shown schematically. The RSU 86 is divided into logical partitions, each of which is one or more logically contiguous blocks of storage. As will be apparent to those of skill in the art, the terms “partition” and “logical partition” are used interchangeably herein. The only limitation to the present invention is that, except in the special case in which partitions that are equal in size may be used, the partitions should re-sizable and/or relocatable. Thus logical partitions and, in some cases, physical partitions that meet this requirement are both intended to be within the scope of the present invention.

Each partition has at least a start position and a length/size that is defined for it. As known to those of skill in the art, partitions are treated for some purposes as if they are separate discrete memory devices. For example, a hard drive with two partitions may appear to application software running on a computer connected to the hard drive as two separate hard drives. Also known to those of skill in the art, logical partitions, and some physical partitions, typically can be added, removed, or resized in order to provide flexibility within the storage device. For logical partitions, this is done by modifying a data structure that is stored in non-volatile rewritable memory or, as is the case in subscriber station 28, reconstructed on startup, as described below. The data structure contains data, such as the start position and size/length discussed above, providing a correspondence between physical locations in the storage device and the logical partitions. Logical partitioning can also make non-contiguous storage locations appear as contiguous blocks of storage to applications. For example, it is possible to partition a flash ROM such that even numbered blocks (i.e.—blocks 0, 2, 4, 6, etc.) appear to applications as one contiguous block of storage while the odd-numbered blocks (i.e.—blocks 1, 3, 5, 7, etc.) appear to applications as another contiguous block. Many other partitioning schemes and arrangements will be apparent to those of skill in the art and are within the scope of the present invention. In subscriber station 28, the RSU 86 is initially divided into three partitions, namely a boot partition 104, a core firmware partition 108 and an auxiliary software partition 112.

The boot partition 104 is located in the first block of the RSU 86 and contains the boot-loading firmware for subscriber station 28. Subscriber station 28 is configured so that at startup (boot) the microprocessor-assembly 72 first executes the instructions found in the first block of the RSU 86, although other schemes, such as reading the last block of RSU 86, etc. can also be employed. The remainder of the blocks of the RSU 86 are initially partitioned into a core firmware partition 108 and an auxiliary software partition 112 in the manner described below. In FIG. 4a, the core firmware partition 108 is shown as occupying the blocks immediately following the boot partition 104 and the auxiliary software partition 112 is shown as occupying the blocks between the last block of the core firmware partition 108 and the end of the RSU 86. As will be discussed below, the initial positioning of the core firmware partition 108 and the auxiliary software partition 112 could be reversed and is reversed as a result of an upgrade (see FIG. 4c in which the reversed order is indicated by adding primes to the reference numerals) as discussed below.

In subscriber station 28, the boot-loading firmware is provided in boot partition 104 to avoid the necessity of providing an additional ROM or other non-volatile storage package in subscriber station 28. However, as will be apparent to those of skill in the art, if such ROM or other non-volatile storage package is provided in memory unit 78 or elsewhere in subscriber station 28, the boot partition 104 can be placed therein and omitted from the RSU 86, which would then be arranged into two partitions 108 and 112. The term “memory sub-system” includes both memory unit 78 and, if boot partition 104 is stored in a ROM or another non-volatile storage package, that ROM or other non-volatile storage package.

The core firmware needed to provide at least minimum functionality to subscriber station 28 is initially written into core firmware partition 108. The core firmware is responsible for providing the basic operations of subscriber station 28. These basic operations can include memory management, task handling, managing files, input/output, etc. and at least the minimum amount of functionality required to allow subscriber station 28 to communicate with the base station 24 (but not necessarily enough functionality to provide any end user services). In subscriber station 28, the operating system included in the core firmware includes the Linux kernel, version 2.4 and the boot-loading software in the boot partition 104 is a Linux boot loader. The core firmware in partition 108 is a cramfs file system, which is a read-only compressed file system that is known to those skilled in the art. Documentation of the cramfs file system is readily available (e.g., see http://sourceforge.net/projects/cramfs/) and its operation will not be further discussed herein.

At start up, once the boot partition has been read and execution of the contents of the partition commences, the boot loader starts reading sequentially from the start of the RSU 86 to locate the starting block and size of the core firmware partition 108. The boot loader does this by looking for a superblock, as defined in the cramfs file system. When one is found it is assumed to be the superblock of the compressed Linux kernel in the core firmware partition 108. The boot loader then uses the information stored in that superblock to decompress the kernel image into the RAM 82 and passes the starting block and size of the core firmware partition 108 as boot parameters to the linux kernel as the operating system starts, so that the partitioning of the RSU can be determined.

While Linux is presently preferred, other operating systems and operating system versions are within the scope of the invention. The location of the core firmware partition 108 within RSU 86 is not particularly limited and can occupy any contiguous set of logical block addresses after the boot partition 104 (if present) as the boot loader searches the contents of the RSU 86 until the start of a valid core firmware partition 108, i.e.—a cramfs superblock, is located. However, as should become clear from the following it is preferred that the core firmware partition 108 be located either immediately after the boot partition 104 or at the end of the RSU 86 to avoid a situation in which one or more memory blocks are not in either the core firmware partition 108 or the auxiliary software partition 112.

The balance of the software and data are stored in the RSU 86 in auxiliary software partition 112. This software is hereinafter referred to as the auxiliary software. The auxiliary software is not particularly limited and can include optional device drivers, user applications, system software applications, data files, software and end user applications such as telephone call processing software, voice and audio codecs, software filters, firewalls, utilities, help files, subscriber data files, digital media files, and other such applications and data files as will occur to those of skill in the art.

The auxiliary software can be stored in a compressed file system format, such as the above-mentioned cramfs format, or in any other suitable manner as will occur to those of skill in the art. If the auxiliary software is monolithic, i.e.—changes or updates to the software require a replacement of the entire contents of the partition, then cramfs, or similar file/storage systems can be a preferred alternative. Alternatively, if the auxiliary software is not monolithic, so that software components can be loaded and/or unloaded in the partition as need, then a suitable system such as JFFS (Journaling Flash File System) developed by Axis Communications AB, Emdalavägen 14, S-223 69, Lund Sweden, can be employed.

Generally, the auxiliary software stored in the auxiliary software partition 112 is not required for subscriber station 28 to communicate with the base station 24, although the auxiliary software stored in the auxiliary software partition 112 may be required to enable subscriber station 28 to make or receive voice calls, end user data connections (such as http browser sessions) or other end user functions. The location of the auxiliary software partition 112 within RSU 86 is not particularly limited and need only occupy a logically contiguous set of blocks but, as discussed above, is preferably either at the end of the blocks of the RSU 86 or immediately following the boot partition 104.

As shown in FIG. 4a, the core firmware partition 108 is smaller in size than the auxiliary software partition 112. However, if the number of blocks available to be partitioned into the core firmware partition 108 and the auxiliary software partition 112 is an even number, then they can be equal in size. In a present embodiment of subscriber station 28, the total storage space available in the RSU 86 is 8 Mbytes, the boot partition 104 is 256 Kbytes, the core firmware partition 108 has a maximum size of 3.75 Mbytes, and the auxiliary software partition 112 has a maximum size of 7.75 Mbytes minus the size of the core firmware partition 108. In the particular embodiment described herein, the maximum size of the auxiliary software block is 4 Mbytes.

As the total number of memory blocks in RSU 86 in the present embodiment is even and as one block is used for the boot partition 104, an odd number of blocks are available to be partitioned into the core firmware partition 108 and the auxiliary software partition 112 and thus the core firmware partition 108 and the auxiliary software partition 112 cannot be equal in size. As will be clear from the following discussion, the critical constraint is that the core firmware partition 108 must be no larger than the auxiliary software partition 112. Then an update of the core firmware can always be written to the auxiliary software partition 112 without overwriting the existing core firmware partition 108. This will be more readily apparent after reading the description below.

When it is desired to update the core firmware in the core firmware partition 108, the update core firmware is transferred from an update server 36, as described in more detail below, over the communications link 32 to subscriber station 28. The core firmware is received and stored in the RAM 82 in subscriber station 28 until the entire transfer of the update core firmware and the auxiliary software to subscriber station 28 has been completed, although it is also contemplated that, if desired, the update core firmware could be transferred and installed before transferring the auxiliary software. Depending upon the size of the update and the size of the RAM 82, it may be necessary to terminate any processes running on subscriber station 28 which require large amounts of RAM 82. As will be discussed below, the ability to terminate such processes is one of the status criteria considered before it is decided to update subscriber station 28.

It is contemplated that a variety of techniques can be used to transfer the core firmware and auxiliary software from the update server 36 to subscriber station 28, such as transmission of the software in packets via UDP/IP or TCP/IP. As the communications link 32 or the physical media (wireline connection, etc.) used to transfer the software can be subject to faults or errors, the correctness of the received transfer of the software is verified before use. The particular method used to verify this correctness is not particularly limited and checksums, CRCs, digital signatures, etc. can be employed on all, or portions, of the transfer, as will be apparent to those of skill in the art. If the received contents are not correct, and contain one or more errors, the software or appropriate portions of it, can be retransmitted from the update server 36 to subscriber station 28 until a complete correct copy is received at subscriber station 28.

Once a complete correct copy of the update/replacement core firmware, i.e.—the “new” core firmware, is received at subscriber station 28 and stored in the RAM 82, the update process continues by writing the new core firmware over all or part of the portion of the RSU 86 previously occupied by the auxiliary software partition 112. In order to perform this overwriting, any remaining processes which were executing on subscriber station 28 and which require read access to the auxiliary software in the auxiliary software partition 112 are terminated. Once these processes, if any, are terminated, the new core firmware is copied from RAM 82 and written to the RSU 86. The new core firmware is indicated in FIG. 4b as a new core firmware partition 108′. As used herein, the terms “overwriting” and “overwritten” are intended to comprise the necessary operations for placing new data into a non-volatile memory to replace previous data and includes, in the case of flash memory, first erasing the memory before writing new data to it, if such a step is necessary.

It is also contemplated that, to reduce the memory required in RAM 82, the updated core firmware can be written in increments as it is received, for example in update blocks of 256 Kbytes, provided that the received update can be verified as having been properly received before writing. In such a case, as a given amount of update data is received at subscriber station 28, it is temporarily stored and verified in the RAM 82 and then written to the RSU 86 while the next received update overwrites the previous received update which had been temporarily stored in the RAM 82. In this manner, various applications and processes running from the RAM 82 may not necessarily have to be terminated, as discussed below, during the update process, at least until subscriber station 28 is rebooted.

As shown in FIG. 4b, the overwriting is commenced at an offset from the beginning of the auxiliary software partition 112 determined so that the end of the new core firmware partition 108′ will coincide with the end of the auxiliary software partition 112. In the example above, if the RSU 86 is 8 megabytes in total size and the core firmware partition 104 is 0.25 megabytes in size, the auxiliary software partition 112 is 4 megabytes in size and the core firmware partition 108 is 3.75 megabytes, so the offset at which the new core firmware partition 108′ is overwritten onto the auxiliary software partition 112 is 4.25 megabytes from the start of the RSU 86, assuming the core firmware partition 104 is in fact present at the beginning of the RSU 86.

After the new core firmware partition 108′ is written, its contents are verified by subscriber station 28, which reads back the contents from the new core firmware partition 108′ and compares them to the copy of the new core firmware in the RAM 82. If the new core firmware partition 108′ is written in smaller portions from the RAM 82 as received, the writing of these smaller portions is verified to that stored in the RAM 82 before the next received portion overwrites the last portion temporarily stored in the RAM 82.

In either case, if the contents read from the new core firmware partition 108′ cannot be verified, the writing of the new core firmware partition 108′, or the relevant portion of the new core firmware partition 108′, is performed again and the verification/rewrite process is repeated until the contents are verified.

When the contents of the new core firmware partition 108′ have been verified as having been written correctly, the new core firmware partition 108′ is identified to subscriber station 28 as containing the most recent core firmware and original core firmware in the core firmware partition 108 is then disabled from being executed by subscriber station 28 by being marked “invalid”. In subscriber station 28, wherein the core firmware partitions 108 and 108′ include a cramfs formatted Linux kernel, etc., the original core firmware in the core firmware partition 108 is identified as invalid by overwriting the superblock of the core firmware partition 108 so as to alter it to no longer be a valid superblock. Once this is done, the boot loader on the next reboot of subscriber station 28 will only locate the superblock of the new core firmware partition 108′, which is the most recent valid core firmware partition, and subscriber station 28 will boot from partition 108′.

As will be apparent from FIG. 4b, the above results in an invalid core firmware partition 108 and a remaining portion, if any, of the auxiliary software partition 112 no longer containing useful data. Subscriber station 28 can then write the auxiliary software from the RAM 82 (or download it to the RAM 82 from update server 36 if this has not yet been performed) to form a new auxiliary software partition 112′ in the memory space of the core firmware partition 108 and that remaining portion, if any, of the auxiliary software partition 112, as shown in FIG. 4c. Alternatively, the subscriber system 28 can be rebooted to execute the new core firmware and the auxiliary software can then be downloaded from the update server and stored in the new auxiliary software partition 112′. Once the writing of the new auxiliary software has been verified in a manner similar to that described above for the core firmware, subscriber station 28 can execute the auxiliary software (assuming it has already rebooted and is running the new core firmware) or can be rebooted to let the loader boot the updated core firmware in the new core firmware partition 108′ and restart all services provided by both the core firmware and the auxiliary software. In doing so, the operating system will locate the superblock of the new core firmware partition 108′ and, if cramfs is employed for the auxiliary software partition, the superblock of the new auxiliary software partition 112′ and form a data structure describing the repartitioned RSU 86.

As will be apparent from the above description, a valid copy of the core firmware is always present in the RSU 86, even if subscriber station 28 is turned off, looses power, requires a reboot, or is otherwise interrupted during the update process. In the event that the update process has commenced with a new core firmware partition 108′ being written over the auxiliary software partition 112 when subscriber station 28 is turned off before the write of the new core firmware partition 108′ has been completed and verified, subscriber station 28 will boot from the old core firmware partition 108, which is still intact, when it is next turned on again. The absence of a valid auxiliary software partition 112 will be noted and the entire update process will either restart, or a transfer of valid auxiliary software can be requested from the update server 36 and stored in the RSU 86 as a restored auxiliary software partition 112 and the update process deferred until later. This latter option will be selected, for example, when the network 20 is being heavily used and the capacity to perform an update is not readily available.

Assuming a successful update has been performed, whenever it is desired to again update core firmware in subscriber station 28, a new core firmware partition 108 will overwrite a portion of the auxiliary software partition 112′ and a new auxiliary software partition 112 will overwrite the old core firmware partition 108′ and the remaining part of the old auxiliary software partition 112′ to again obtain the configuration shown in FIG. 4a. It should be noted that it is not strictly necessary to erase the superblock of the old core firmware partition 108′ after the new core firmware partition 108 is verified because, if the updating is interrupted at that stage, then when a reboot occurs the boot loader will locate and use the contents of new core firmware partition 108 before reaching old core firmware partition 108′.

Each subsequent update of core firmware will result in the overwriting of the existing auxiliary software partition by the new core firmware partition and the overwriting of the old core firmware partition and the remaining portion of the auxiliary software partition with a new auxiliary software partition.

It should be noted that, as used herein, the term “new auxiliary software” is intended to comprise both the case wherein no change has occurred in the auxiliary software and the new auxiliary software merely refers to a new copy of that unchanged software being downloaded to the subscriber station 28 and the case wherein an updated or otherwise changed version of the auxiliary software is downloaded to subscriber station 28.

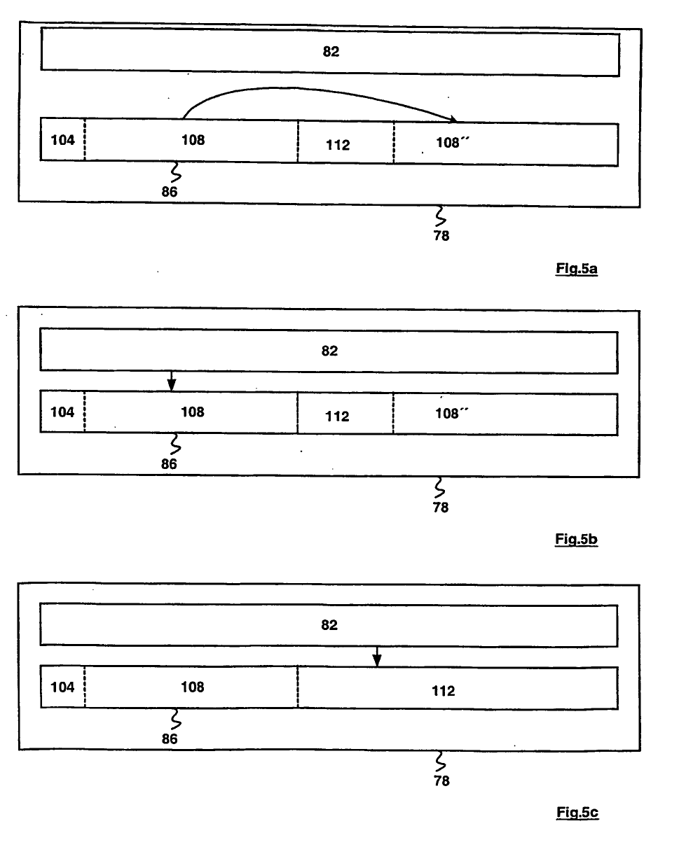

As shown in FIG. 5a, if it is desired to have the location of the partitions 108 and 112 be constant in the RSU 86 during normal operations, the “old” core firmware partition 108 can be copied over the “old” auxiliary software partition 112 to form a copied old core firmware partition 108″. The writing of this copied old core firmware partition 108″ is then verified and, once verified, the original core firmware partition 108 is identified as invalid by overwriting its superblock so as to alter it or by any other suitable means. Should subscriber station 28 be re-booted at this point for any reason, the boot loader will locate and use the contents of the copied core firmware partition 108″.

Next, the “new” core firmware is overwritten onto the original core firmware partition 108 from the RAM 82, as shown in FIG. 5b, and verified. The superblock of the new core firmware for original core firmware partition 108 is not written to original core firmware partition 108 until the contents of the remainder of the core firmware partition 108 are verified, after which the superblock is written and verified. Then the copied core firmware partition 108″ is identified as invalid by overwriting or altering its superblock or by any other suitable means. In this manner, a reboot or other event requiring loading of the core firmware prior to verification of the write of the new core firmware partition 108 will instead employ the copied core firmware partition 108″.

Finally, the new auxiliary software is copied from the RAM 82 to form the auxiliary software partition 112, as shown in FIG. 5c and this partition is verified before being used and subscriber station 28 is then once again in its normal operating configuration. While this process does result in the partitions 108, 112 always having the same positions in the RSU 86, it does require additional write and verification operations to be performed to copy the contents of core firmware partition 108 to the copied core firmware partition 108″, which adds to the time required to perform the update and, if the RSU 86 is flash memory, may cause the RSU 86 to wear out more quickly.

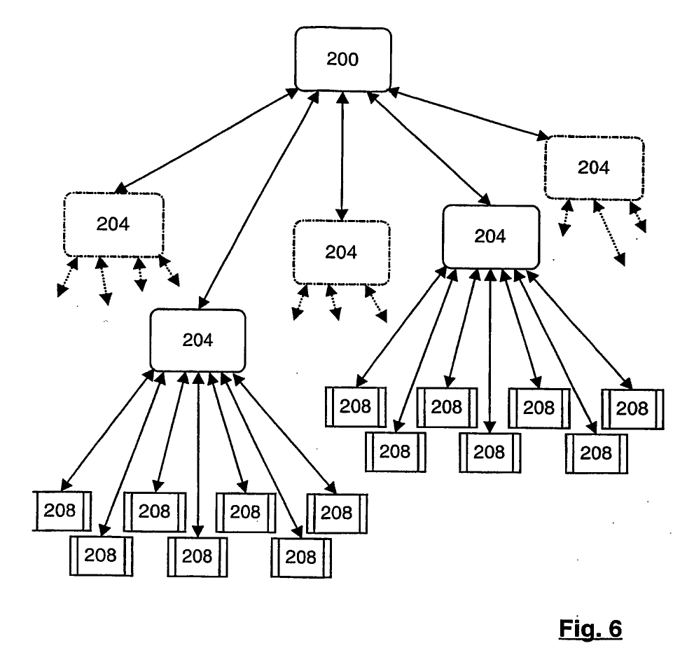

In a present embodiment of the invention, updating of software in the subscriber stations 28 is a managed process. This is especially important in a critical network or an “always on” network, such as wireless local loop providing a primary telephone line replacement FIG. 6 shows the management system hierarchy of the network 20 which includes a network operations center (NOC) 200, a radio sector manager 204 for each sector in a base station 24 in network 20 and a subscriber station update client 208 for each subscriber station 28 served by the network 20.

The network operations center 200 is a centrized facility operated by the operator of the network 20 and, in addition to managing the updating of subscriber stations throughout the network 20, can also perform other network management functions such as OAM&P, etc. Radio sector managers 204 are preferably located in each base station 24 of the network 20 and can be co-located with or implemented within the update server 36. If a base station 24 is an omni-directional (single sector) base station, only a single radio sector manager 204 will be provided in that base station 24. It is contemplated that, more commonly, a base station 24 will employ non-omni-directional (beam-forming) antennas which allow it to serve increased densities of subscriber stations 28. For example, if sixty degree beam-forming antennas are employed, a base station 24 can be configured into six different radio sectors, each sector serving a subset of the total number of subscriber stations 28 served by that base station 24. In such a case, six radio sector managers 204 are provided at base station 24. Finally, each subscriber station 28, as part of its core firmware, includes an update client 208, which executes on subscriber station 28.

In FIG. 6, the radio sector managers 204 illustrated in dashed line are intended to represent a plurality of such radio sector mangers 204 and their associated update clients as NOC 200 can serve several hundreds of radio sector managers 204 and, through them, several thousand or more subscriber stations 28 through their update clients 208.

When an update to the auxiliary software or core firmware of subscriber stations 28 has been created and the operator of network 20 wishes to implement it, the network operations center 200 will determine the present version of the software loaded into each subscriber station 28 being served by network 20. This determination can be performed in a variety of manners, as will be apparent to those of skill in the art. In the embodiment of the invention, the update client 208 of each subscriber station 28 reports to the radio sector manager 204 serving it the present version of the software loaded into subscriber station 28 each time the subscriber stations 28 is turned on and/or after each time an update is performed. The radio sector managers 204 forward this information to the network operations center 200 where it is stored in a suitable database. As will be apparent to those of skill in the art, a variety of other techniques can be employed to determine the present software load of each subscriber station 28, including polling of the update clients 208 at appropriate intervals, etc.

Once the present software load of each subscriber station in network 20, or in a subset of interest of the subscriber stations 28 in network 20 (for example, the network operator can be interested in only updating those subscriber stations 28 in a particular city), has been determined, network operations center 200 determines the subscriber stations 28 that should be updated. In most circumstances, it will be desired to update all subscriber stations 28 in network 20, but it is also contemplated that it can be desired to update selected subsets of subscriber stations 28, or even individual subscriber stations 28.

The network operations center 200 ensures that the desired updated software is available on the update server, or servers 36, which serve the radio sector managers 204 with subscriber stations 28 to be updated, transferring the updated software to the update servers 36 as necessary. Next, network operations center 200 instructs the radio section managers 204 with subscriber stations 28 to be updated of the identity of those subscriber stations 28 and instructs them to initiate the updates.

Once a radio sector manager 204 receives update instructions from the network operations center 200, it determines the activity level and or status of the subscriber stations 28 it manages that are to be updated. Ideally, updates are only performed when the capacity they require on communications link 32 is not otherwise required and/or subscriber stations 28 are not executing end user processes that will have to be interrupted for the update process. Accordingly, radio sector manager 204 first determines that it can spare and/or has capacity on communications link 32 to transmit the update. It is contemplated that typically, such updates will be performed late at night or early in the morning when communications link 32 is underutilized by end users. However, it is also contemplated that an essential update, such as one required to stabilize operation of network 20 or to provide enhanced security, etc. can be assigned an update priority by network operations center 200 which instructs radio sector managers 204 to perform the update as soon as possible, terminating or interrupting other uses of the capacity of communications link 32 and/or interrupting, degrading or suspending end user activities at the subscriber stations 28 to be updated.

Once it has been determined by radio sector manager 204 that it has capacity on communications link 32 to transmit the update to subscriber stations 28, or in the event of a priority update that it has made capacity, it queries the update client 208 in each of those subscriber stations 28 it is to update to determine the status of those subscriber stations 28. This status indicates the level and/or type of activity presently taking place on that subscriber station 28.

For example, a subscriber station 28 can indicate that it has been idle (no end user activity) for ten minutes, or that it is currently conducting an http session for an end user, etc. As the transferred download of the update is typically first stored in RAM memory 82, if the necessary amount of memory (this amount can be a predefined amount for all updates, or can be provided by the radio sector manager 204 in its status query to the update clients 208) selected to store the download is not available in RAM memory 82, subscriber station 28 will include this information in its status report to radio sector manager 204. Alternatively, the update client 208 in subscriber station 23 can determine if it can terminate processes and/or applications using RAM memory 82 to free memory space and will do so, if possible, before sending the status response to radio sector manager 204.

Radio sector manager 204 examines the status responses received from each subscriber station 28 to be updated and determines which subscriber stations 28 can be included in the update at this time. The update client 208 of each of these subscriber stations 28 then receives an update information transmission from radio sector manager 204 informing the subscriber stations 28 that they are to undergo an update and indicating the channel of communications link 32 that the update is to be transmitted on.

Radio sector manager 204 then initiates a multicast transmission of the update from update server 36 to the subscriber stations 28 which have been instructed to process the update. In the embodiment of the invention, the update is transmitted via UDP over IP as a multicast transmission and each transmitted packet includes a CRC checksum to verify correct receipt and a sequence number or other unique identifier of the packet so that each subscriber station 28 can determine if it has correctly received all necessary packets. In the event that one or more packets have been received incorrectly or missed altogether by a subscriber station 28, such subscriber stations 28 can send a retransmit request to radio sector manager 204 while the transmission is in progress and the requested packet can be retransmitted. Preferably, this retransmission is performed over the multicast channel and is available to all subscriber stations 28 being updated (in case more than one subscriber station 28 requires the retransmission of the same packet) although it is also contemplated that such retransmissions can be made to a subscriber station over a dedicated channel on communications link 32 established with subscriber station 28 by radio sector manager 204 for that purpose.

In the embodiment, once the entire update has been downloaded and verified, the update client in the subscriber station must determine when to perform the update of RSU 86. As the update will require a reboot (restart) of subscriber station 28, update client 208 attempts to select a time for the update when minimal, if any, service interruption to the end users will occur. Again, it is contemplated that such updates will typically be performed late at night or early in the morning or at any other time when the likelihood of end user use of subscriber station 28 is low.

However, the update client 208 in a subscriber station 28 can also make an intelligent decision on when to perform the update by determining what end user activities are occurring and/or the time since the last end user activity. For example, a subscriber station 28 which last made an end user voice or data connection more than twenty minutes ago, can make a reasonable assumption that it will be unused by an end user for the next several minutes while the update is performed.

Again, it is also contemplated that some updates will have sufficient importance to the operations of network 20 that they will have a priority assigned to them that enables the update client 208 to terminate end user activities on the subscriber station in order to ensure the update is performed.

When the update client 208 has determined that the update can be performed, the process discussed above is performed overwriting auxiliary software partition 112 with new firmware partition 108′, or copied partition 108, etc.

Once a successful update has been performed and subscriber station 28 has rebooted and is executing the new core firmware and/or auxiliary software, an update status message is sent to radio sector manager 204 informing it that the update has been completed and verifying the version numbers of the software being executed by subscriber station 28. Radio sector manager 204 then updates its records of the subscriber stations 28 that have been updated and those that still require updating.

Radio sector managers 204 then repeat the process, through one or more iterations, for the remaining subscriber stations 28 to be updated. It is contemplated that an update will not be commenced until a pre-selected proportion of the subscriber stations 28 to be updated in a radio sector are available for the update. For example, it can be selected that radio sector manager 204 will not commence the update unless at least 50% of the subscriber stations 28 to be updated in its sector are available for updating. If this threshold is not reached, the update will be delayed until the threshold can be met or until the network operations center lowers the threshold (eg. to 35%) or raises the priority of the update so that subscriber stations 28 are forced to implement the update.

Network operations center 200 is advised of the status of the update by the radio sector managers 204. Thus, network operations center 200 can determine the number of subscriber stations 28 that have been updated and the number that remain to be updated. If network operations center 200 observes that the update is being performed for fewer subscriber stations 28 than it desires, it can apply priority to the update to force subscriber stations 28 to ready themselves for the update, etc.

While it is contemplated that in most circumstances the core firmware and auxiliary software updates will be transmitted as one update, it is also contemplated that in some circumstances it may be desired to transmit the core firmware update first and, after the subscriber stations 28 have successfully installed that update, the auxiliary software update will be transmitted. It is also contemplated that in some circumstances it will be desirable to only update the auxiliary software. In such a case, the core firmware is not updated and the updated auxiliary software is written over the existing auxiliary software partition 112.

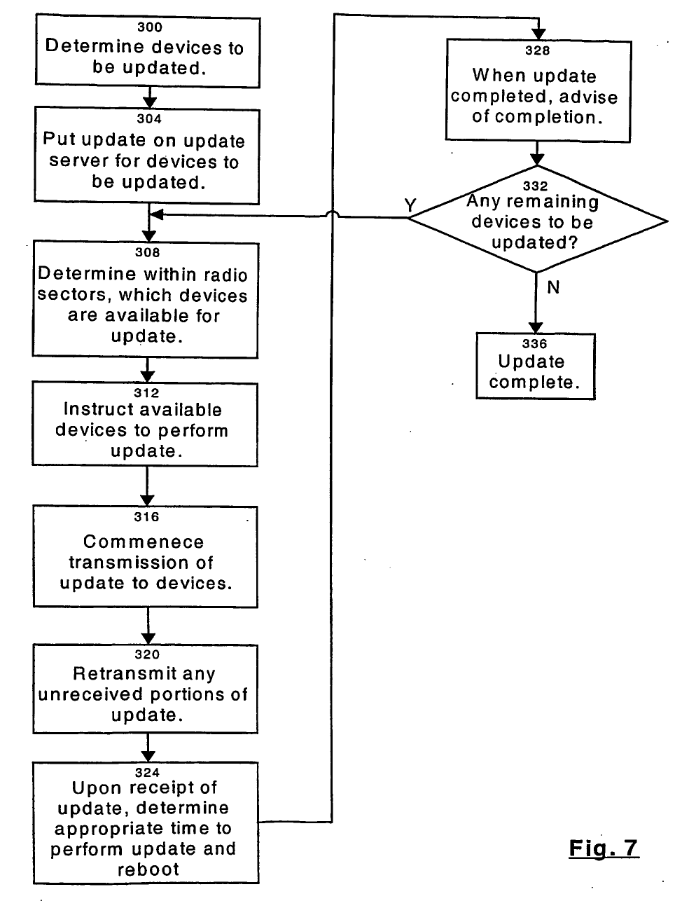

FIG. 7 shows a flowchart of the update process described above. When the network operations center 200 wishes to update devices in network 20, at step 300 the devices that require the update to be installed are determined. At step 304 the update is transferred or otherwise made available to the update server 36, or servers, from which the update will be transferred to the devices to be updated.

At step 308, each radio sector manager 204 determines which of the devices it serves are available for updating. At step 312, the radio sector manager 204 instructs those devices that they will be updated and provides the details of the update communication, such as the multicast parameters, etc.

At step 316, the update is transmitted to the devices being updated. Each intended device verifies the reception of the transmitted update, either when the transmission is completed or as the transmission is occurring, and at step 320, devices which have received a portion of the transmission which is in error or have missed reception of a portion of the transmission advise the radio sector manager 204 of this fact and the radio sector manager 204 which will cause those portions to be retransmitted.

At step 324, once the devices have a correct copy of the update, the devices determine the appropriate time to perform the update. As mentioned above, this determination can be trivial (i.e. —perform the update regardless of the status of the device) or can be made depending upon the status of the device, including factors such as current processes executing on the device, the time since an end user process was executed, etc.

When the update and rebooting of the device is achieved, at step 328 the device will notify the radio sector manager 204 managing it that it has been updated and can provide the details of its present software load.

At step 332, each radio sector manager 204 determines if any devices it manages remain to be updated. If such devices do remain, steps 308 through 328 are performed again, as necessary. If no such devices remain, the update process completes at step 336.

While the embodiments discussed herein are directed specific implementations of the invention, it will be understood that combinations, sub-sets and variations of the embodiments are within the scope of the invention.

The above-described embodiments of the invention are intended to be examples of the present invention and alterations and modifications may be effected thereto, by those of skill in the art, without departing from the scope of the invention, which is defined solely by the claims appended hereto.

1. A method of updating software in a plurality of remote devices each of which has insufficient non-volatile rewritable storage capacity to store both an updated and a previous version of the software and each of which is connected to a network, comprising the steps of:
(i) placing the update onto an update server, the update comprising at least a core firmware update;
(ii) identifying the devices connected to the network to be updated;
(iii) transferring the update from the update server to the identified devices through the network, each identified device verifying the reception of the update, requesting retransmission of and receiving any previously incorrectly received portion of the update;
(iv) writing the core firmware portion of the received update into a non-volatile rewritable storage unit so as not to overwrite the previous version of the core firmware that is present in the storage unit;
(v) verifying the core firmware portion of the received update written into the storage unit;
(vi) identifying the verified updated core firmware as being the valid core firmware to be used by the device and identifying the previous version of the core firmware as being unusable; and
(vii) rebooting the device to load and execute the updated software.

2. The method of claim 1 wherein, between steps (iii) and (iv), the previous version of the core firmware is copied over auxiliary software stored in the storage unit and verified, the copy identified as the valid core firmware to be used by the device and the original identified as being unusable.

3. The method of claim 2 wherein the update further includes updated auxiliary software and the auxiliary software is received and verified by the device and wherein, between steps (vi) and (vii), the unusable previous version of the core firmware is overwritten with the auxiliary software update.

4. The method of claim 1 wherein the update further includes updated auxiliary software and the auxiliary software is received and verified by the device and wherein, between steps (vi) and (vii), the unusable previous version of the core firmware is overwritten with the auxiliary software update.

5. The method of claim 1, wherein step (ii) also comprises the device informing the network whether or not it is available to be updated.

6. A system for remotely updating core firmware in at least one electronic device across a communications link, the system comprising
a memory sub-system within the at least one electronic device including:
non-volatile rewritable memory in which the core firmware is stored and which is sufficiently large to store auxiliary software but not large enough to simultaneously store the core firmware, an updated version of the core firmware, and the auxiliary software, the core firmware including instructions for
writing an updated version of the core firmware into the non-volatile rewritable memory so as not to overwrite the previous version of the core firmware, and then
disabling the previous version of the core firmware such that on rebooting of the at least one electronic device the updated version of the core firmware will be loaded and executed; and
an update server, operable to transfer an update to the at least one electronic device across the communications link, the update comprising the updated version of the core firmware.

7. The system of claim 6, wherein the core firmware includes instructions for writing an updated version of the auxiliary software into the non-volatile rewritable memory so as to overwrite at least a portion of the disabled previous version of the core firmware, but not to overwrite the updated version of the core firmware.

8. The system of claim 7, wherein the memory sub-system additionally comprises:
non-volatile memory including instructions that are executed when the electronic device reboots and cause the non-volatile rewritable memory to be scanned for a version of the core firmware that is not disabled and that version of the core firmware to be loaded and executed.

9. (Cancelled)

10. (Cancelled)

11. (Cancelled)

12. The system as claimed in claim 6, wherein writes to the non-volatile rewritable memory are verified.

13. The system as claimed in claim 12 wherein the update client is further operable to inform the update server as to whether the at least one electronic device is available for updating at a given time, the update server being responsive to the information received from the update client to delay updates to the electronic device when the electronic device is not available for updating.

14. The system as claimed in claim 13 wherein the update server can prioritize an update such that the update client will make the electronic device available for the update that would otherwise be unavailable.

15. A memory sub-system for use in an electronic device, comprising:
non-volatile rewritable memory in which core firmware and auxiliary software are stored, the core firmware including instructions for
writing an updated version of the core firmware into the non-volatile rewritable memory so as to overwrite at least a portion of the auxiliary software, but not to overwrite the previous version of the core firmware,
verifying the updated version of the core firmware, and
disabling the previous version of the core firmware such that on rebooting of the electronic device the updated version of the core firmware will be loaded and executed.

16. (Cancelled)

17. The memory sub-system of claim 15, wherein the core firmware includes instructions for writing an updated version of the auxiliary software into the non-volatile rewritable memory so as to overwrite at least a portion of the disabled previous version of the core firmware, but not to overwrite the updated version of the core firmware.

18. The memory sub-system of claim 17, additionally comprising:
non-volatile memory including instructions that are executed when the electronic device reboots and cause
the non-volatile rewritable memory to be scanned for a version of the core firmware that is not disabled and
the version of the core firmware that is not disabled to be loaded and executed.

19. (Cancelled)

20. (Cancelled)

21. (Cancelled)

22. A method of updating core firmware stored in non-volatile rewritable memory of an electronic device together with auxiliary software with an updated version of the core firmware, comprising the steps of:
(i) writing the updated version of the core firmware into the non-volatile rewritable memory so as to overwrite at least a portion of the auxiliary software, but not to overwrite the previous version of the core firmware; and
(ii) disabling the previous version of the core firmware such that on rebooting of the electronic device the updated version of the core firmware will be loaded and executed.

23. (Cancelled)

24. The method of claim 22, wherein when the electronic device is rebooted, the non-volatile rewritable memory is scanned for a version of the core firmware that is not disabled and that version of the core firmware is then loaded and executed.

25. (Cancelled)

26. A system for remotely updating at least one electronic device across a communications link, where said system comprises:
an update server, operable to transfer an update to the at least one electronic device across the communications link, the update comprising core firmware and auxiliary software;
a volatile memory to temporarily store the transfer received from the update server;
a non-volatile re-writable storage unit within said at least one electronic device divided into at least first and second partitions, the first partition storing one of a version of core firmware and auxiliary software and the second of the partitions storing the other of a version of core firmware and auxiliary software; and
an update client executing on the device and operable:
(i) to overwrite the version of the auxiliary software stored in one of the first and second partitions with the received updated core firmware stored in the volatile memory and to verify the success of this write;
(ii) to configure the device to execute the core firmware stored in (i) upon the next reboot of the device;
(iii) to overwrite the version of the core firmware stored in the other of the first and second partition with the received updated auxiliary software store in the volatile memory and to verify the success of this write; and
(iv) to reboot the device to execute the updated core firmware and updated auxiliary software.

27. The system as claimed in claim 26 wherein said update client is further operable to inform the update server as to whether the device is available for updating at a given time, the update server being responsive to the information received from the update server to delay updates to the device when the device is not available for updating.

28. The system as claimed in claim 27 wherein the update server can prioritize an update such that the update client will make a device available for the update that would otherwise be unavailable.
